(19) United States
(12) Patent Application Publication
(10) Pub. No.: US 2024/0199860 A1
(43) Pub. Date: Jun. 20, 2024

(54) RUBBER COMPOSITION FOR TIRES

(71) Applicant: The Yokohama Rubber Co., LTD., Kanagawa (JP)

(72) Inventors: Makoto OZAKI, Kanagawa (JP); Katsunori SHIMIZU, Kanagawa (JP)

(21) Appl. No.: 18/555,334

(22) PCT Filed: Mar. 18, 2022
(86) PCT No.: PCT/JP2022/012782

§ 371 Date: Oct. 13, 2023

(30) Foreign Application Priority Data
Apr. 20, 2021 (JP) 2021-071039

(51) Int. Cl. C08L 7/00; B60C 1/00; C08K 3/04; C08K 3/36; C08K 5/00

(52) U.S. Cl. CPC C08L 7/00; B60C 1/0016; C08K 3/04; C08K 3/36; C08K 5/005; C08K 2201/006; C08L 2205/03

(57) ABSTRACT

Provided is a rubber composition for tires. From 35 parts by mass to 60 parts by mass of carbon black having a CTAB adsorption specific surface area of less than 70 m²/g and from 3 parts by mass to 30 parts by mass of silica having a CTAB adsorption specific surface area of less than 180 m²/g are blended per 100 parts by mass of a rubber component containing 50 mass % or more of natural rubber and from 10 mass % to 40 mass % of butadiene rubber. The butadiene rubber uses an unmodified butadiene rubber having a cis-1,4 bond content of 97% or more, a Mooney viscosity ML₁₊₄ at 100° C. of 45 or more, and a ratio Tcp/ML₁₊₄ of a 5 mass % toluene solution viscosity Tcp (unit: cps) at 25° C. to the Mooney viscosity ML₁₊₄ ranging from 2.0 to 3.0.

### TECHNICAL FIELD

The present technology relates to a rubber composition for tires that is intended mainly for use in an undertread portion of a tire.

### BACKGROUND ART

With the recent rising demand for environmental protection, reducing tire rolling resistance to improve fuel economy performance during travel has been awaited. Suppressing heat generation of a rubber composition constituting each portion of the tire (for example, a rubber composition constituting a tread portion) is known to be effective for improvement of the fuel economy performance. For example, when a tread portion is constituted by a cap tread forming a road contact surface and a base tread (undertread) disposed on an inner side of the cap tread as in a tire of Japan Patent No. 6025494 B, improvement of the fuel economy performance using a rubber composition having low heat generation in the undertread has been proposed. When the undertread has low heat generation as described above, further increasing a rubber gauge of the undertread is effective for improving the fuel economy performance.

On the other hand, known examples of a method for reducing heat build-up of the rubber composition, specifically, a method for reducing rubber physical properties (for example, tan δ at 60° C. by dynamic viscoelasticity measurement) serving as an index of the heat build-up include reducing a blended amount of a filler such as carbon black or increasing a particle diameter of carbon black. Alternatively, blending silica is also known to be effective in reducing the heat build-up. Unfortunately, reducing heat build-up by these methods may result in insufficient rubber hardness and fatigue resistance, causing a concern about degradation of steering stability due to a decrease in cornering power and an influence on durability (durability during high-speed travel and durability against groove cracks) when the rubber composition is used for the tire (in particular, when used for the undertread portion). Thus, in improving the fuel economy performance (reducing heat build-up) by using the undertread, measures for satisfactorily maintaining the steering stability and the durability when a tire is made are awaited.

### SUMMARY

The present technology provides a rubber composition for tires that can provide reduced rolling resistance while providing satisfactorily maintained and improved steering stability and durability when used in a tire.

A rubber composition for tires according to an embodiment of the present technology includes from 35 parts by mass to 60 parts by mass of carbon black having a CTAB (cetyltrimethylammonium bromide) adsorption specific surface area of less than 70 m²/g and from 3 parts by mass to 30 parts by mass of silica having a CTAB adsorption specific surface area of less than 180 m²/g blended per 100 parts by mass of a rubber component containing 50 mass % or more of natural rubber and from 10 mass % to 40 mass % of butadiene rubber. The butadiene rubber is an unmodified butadiene rubber having a cis-1,4 bond content of 97% or more, a Mooney viscosity ML₁₊₄ at 100° C. of 45 or more, and a ratio Tcp/ML₁₊₄ of a 5 mass % toluene solution viscosity Tcp (unit: cps) at 25° C. to the Mooney viscosity ML₁₊₄ ranging from 2.0 to 3.0.

The rubber composition for tires according to an embodiment of the present technology uses specific butadiene rubber satisfying the above conditions in combination with natural rubber as a rubber component and blends a suitable amount of each of carbon black and silica having a large particle diameter as a filler, thus allowing the steering stability and the durability to be improved while the rolling resistance is reduced when the rubber composition is used in a tire.

In an embodiment of the present technology, the “CTAB adsorption specific surface area” is measured in accordance with ISO (International Organization for Standardization) 5794. The “cis-1,4 bond content” is a ratio of a cis-1,4 bond among a cis-1,4 bond, a trans-1,4 bond, and a 1,2-vinyl bond which are bonding forms of butadiene and is measured by infrared emission spectroscopy (Hampton technique). The “Mooney viscosity ML₁₊₄ at 100° C.” is measured in accordance with JIS (Japanese Industrial Standard) K 6300-1:2001, by using an L-type rotor in a Mooney viscometer, and under conditions of preheating time of 1 minute, rotor rotation time of 4 minutes, and 100° C. The “5 mass % toluene solution viscosity Tcp at 25° C.” is a viscosity of a toluene solution containing 5 wt. % of target butadiene rubber and is measured at 25° C. by using a Cannon-Fenske viscometer.

An embodiment of the present technology can have a specification of the rubber component further including isoprene rubber or styrene-butadiene rubber.

In an embodiment of the present technology, preferably, hardness at 20° C. ranges from 60 to 65, tensile stress (M100) at 100% elongation at 100° C. ranges from 2.0 MPa to 4.0 MPa, and a product (TB×EB) of tensile strength at break TB (unit: MPa) at 100° C. and elongation at break EB (unit: %) at 100° C. is 2000 or more. The rubber composition having such rubber physical properties advantageously improves the steering stability and the durability while reducing the rolling resistance when used in the tire.

In an embodiment of the present technology, “hardness” is a hardness of a rubber composition measured in accordance with JIS K 6253 and by using a Type A durometer at a temperature of 20° C. The “tensile stress (M100) at 100% elongation at 100° C.” is a value measured in accordance with JIS K6251, by using a No. 3 dumbbell test piece, and under conditions of a tensile speed of 500 mm/minute and a temperature of 100° C. The “tensile strength at break TB at 100° C.” is a value (unit: MPa) measured in accordance with JIS K6251 and at a temperature of 100° C. The “elongation at break EB at 100° C.” is a value (unit: %) measured in accordance with JIS K6251 and at a temperature of 100° C.

The rubber composition for tires according to an embodiment of the present technology described above can be suitably used for an undertread in a tire that includes a tread portion extending in a tire circumferential direction and having an annular shape, a cap tread constituting a road contact surface of the tread portion, and the undertread disposed on an inner circumferential side thereof. A tire in which the rubber composition for tires according to an embodiment of the present technology is used for the undertread (hereinafter, referred to as a tire according to an embodiment of the present technology) can provide low rolling resistance, steering stability, and durability in a highly compatible manner by the above-described characteristics of the rubber composition for tires according to an embodiment of the present technology. The tire to which the rubber composition for tires according to an embodiment of the present technology is applied is preferably a pneumatic tire but may be a non-pneumatic tire. In a case of a pneumatic tire, the interior thereof can be filled with air, inert gas such as nitrogen, or other gases.

In the tire according to an embodiment of the present technology, an under-groove gauge G_{T} at a groove bottom of a circumferential groove formed in the tread portion is preferably 2.5 mm or less. A ratio G_{U}/G_{C} of a rubber gauge G_{U} of the undertread to a rubber gauge G_{C} of the cap tread at a groove bottom of the circumferential groove preferably ranges from 0.3 to 0.8. Having such dimensions satisfactorily balances the tread portion, the cap tread, and the undertread at a groove bottom position, thus advantageously improving the steering stability and the durability (in particular, durability against groove cracks) while reducing the rolling resistance.

In the tire according to an embodiment of the present technology, from 1.0 part by mass to 4.0 parts by mass of an amine-based anti-aging agent is preferably blended per 100 parts by mass of the rubber component. At this time, preferably, a content A of an amine-based anti-aging agent in the cap tread at the groove bottom position of the circumferential groove is more than 0.8 mass % and less than 2.0 mass %, a content B of the amine-based anti-aging agent in the undertread at the position under the circumferential groove is more than 0.7 mass % and less than 1.5 mass %, and a ratio B/A of the content B to the content A is 0.6 or more and 1.2 or less. This makes the physical properties of the undertread (in particular, physical properties at the groove bottom position) satisfactory, thus advantageously improving the steering stability and the durability (in particular, durability against groove cracks) while reducing the rolling resistance.

In an embodiment of the present technology, the content of the amine-based anti-aging agent is a measurement value in an untraveled new tire and can be measured by, for example, gas chromatography in accordance with JIS K 6229 and JIS K 0114 as described below. That is, the untraveled new tire is disassembled, the cap tread and the undertread at the groove bottom position of the circumferential groove are each thinly sliced, then cut into a test piece having a size of about 1 mm square and a length of about 30 mm, and extracted with acetone for 8 hours, and the resulting filtrate is returned to room temperature to obtain a gas chromatographic measurement sample. In addition, a solution (standard sample) in which a four-point concentration of the amine-based anti-aging agent to be measured is distributed in a range of from 100 ppm to 1000 ppm is prepared. Then, an area of the obtained gas chromatographic measurement sample is determined, and the content of the amine-based anti-aging agent in the gas chromatographic measurement sample is calculated from a calibration curve.

When the tire according to an embodiment of the present technology is manufactured, a vulcanization temperature preferably ranges from 145° C. to 170° C. Setting the temperature condition in this manner further makes the physical properties of the undertread satisfactory, thus advantageously improving the steering stability and the durability while reducing the rolling resistance.

### BRIEF DESCRIPTION OF DRAWINGS

FIG. 1 is a meridian cross-sectional view of a pneumatic tire according to an embodiment of the present technology.

### DETAILED DESCRIPTION

Configurations of embodiments of the present technology will be described in detail below with reference to the accompanying drawings.

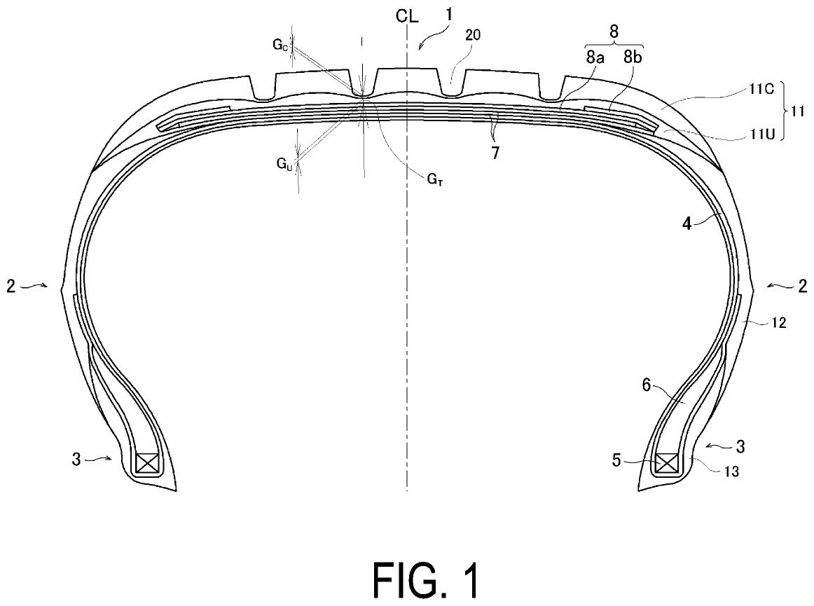

As illustrated in FIG. 1, a pneumatic tire according to an embodiment of the present technology includes a tread portion 1, a pair of sidewall portions 2 respectively disposed on both sides of the tread portion 1, and a pair of bead portions 3 each disposed on an inner side of the pair of sidewall portions 2 in a tire radial direction. “CL” in FIG. 1 denotes a tire equator. Although not illustrated in FIG. 1, which is a meridian cross-sectional view, the tread portion 1, the sidewall portions 2, and the bead portions 3 each extend in a tire circumferential direction and having an annular shape. This forms a toroidal basic structure of the pneumatic tire. Although the description using FIG. 1 is basically based on the illustrated meridian cross-sectional shape, all of the tire components extend in the tire circumferential direction and form the annular shape.

A carcass layer 4 is mounted between the left-right pair of bead portions 3. The carcass layer 4 includes a plurality of reinforcing cords extending in the tire radial direction and is folded back around a bead core 5 disposed in each of the bead portions 3 from a vehicle inner side to a vehicle outer side. Additionally, a bead filler 6 is disposed on the periphery of the bead core 5, and the bead filler 6 is enveloped by a body portion and a folded back portion of the carcass layer 4. On the other hand, in the tread portion 1, a plurality of belt layers 7 (two layers in FIG. 1) are embedded on an outer circumferential side of the carcass layer 4. The belt layers 7 each include a plurality of reinforcing cords inclining with respect to the tire circumferential direction and are disposed such that the reinforcing cords of the different layers intersect each other. In these belt layers 7, the inclination angle of the reinforcing cords with respect to the tire circumferential direction is set in a range of, for example, from 10° to 40°. Moreover, a belt reinforcing layer 8 (two layers including a full cover 8a covering the entire width of the belt layer 7 and an edge cover 8b locally covering an end of the belt layer 7) is provided on an outer circumferential side of the belt layer 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

A tread rubber layer 11 is disposed on the outer circumferential side of the carcass layer 4 in the tread portion 1. A side rubber layer 12 is disposed on the outer circumferential side (outer side in the tire width direction) of the carcass layer 4 in each of the sidewall portions 2. A rim cushion rubber layer 13 is disposed on the outer circumferential side (outer side in the tire width direction) of the carcass layer 4 in each of the bead portions 3. The tread rubber layer 11 has a structure in which two types of rubber layers having different physical properties (a cap tread 11C constituting a road contact surface of the tread portion 1 and an undertread 11U disposed on an inner circumferential side of the cap tread 11C) are stacked in the tire radial direction.

The rubber composition for tires according to an embodiment of the present technology is mainly used for the undertread 11U of the tire as described above. Thus, in the tire to which the present technology is applied, as long as the tread portion 1 (tread rubber layer 11) includes the cap tread 11C and the undertread 11U, a basic structure of other portions is not limited to the above-described structure.

In the rubber composition for tires according to an embodiment of the present technology, the rubber component is diene rubber and always contains natural rubber and butadiene rubber. The rubber composition for tires according to an embodiment of the present technology may optionally contain isoprene rubber or styrene-butadiene rubber. These optionally blended diene rubber can be used alone or as a freely chosen blend.

As natural rubber, rubber that is typically used in rubber compositions for tires can be used. Blending a natural rubber can obtain sufficient rubber strength as a rubber composition for tires. When the entire amount of the diene rubber is 100 mass %, the blended amount of the natural rubber is 50 mass % or greater, preferably from 60 mass % to 90 mass %, and more preferably from 65 mass % to 85 mass %. However, when the isoprene rubber is used in combination as an optional component, a total of the natural rubber and the isoprene rubber preferably ranges from 60 mass % to 90 mass %, and more preferably from 65 mass % to 85 mass %. The blended amount of the natural rubber of less than 50 mass % cannot have the sufficient rubber strength.

The butadiene rubber used in the present technology is an unmodified butadiene rubber and has physical properties of the cis-1,4 bond content of 97% or more, the Mooney viscosity ML₁₊₄ at 100° C. of 45 or more, and the ratio Tcp/ML₁₊₄ of the 5 mass % toluene solution viscosity Tcp (unit: cps) at 25° C. to the Mooney viscosity ML₁₊₄ ranging from 2.0 to 3.0. Using the butadiene rubber having such characteristics and thus using a polymer having high linearity with less branching of polymer chains of the butadiene rubber allows heat build-up to be reduced.

The cis-1,4 bond content of the butadiene rubber used in the present technology is 97% or more as described above, preferably from 98% to 100%, and more preferably from 99% to 100%. The high cis-1,4 bond content is advantageous for improving break strength and elongation at break. If the cis-1,4 bond content is less than 97%, the break strength, the elongation at break, and cold resistance are reduced. An increase or decrease in the cis-1,4 bond content of the butadiene rubber can be appropriately adjusted by an ordinary method such as a catalyst.

The Mooney viscosity ML₁₊₄ at 100° C. of the butadiene rubber used in the present technology is 45 or more as described above, preferably from 45 to 52, and more preferably from 45 to 50. Having the specific Mooney viscosity ML₁₊₄ as described above can provide the processability, the break strength, and the elongation at break in a compatible manner. The Mooney viscosity ML₁₊₄ of less than 45 decreases the break strength.

In the butadiene rubber used in the present technology, the ratio Tcp/ML₁₊₄ ranges from 2.0 to 3.0 as described above, preferably from 2.2 to 3.0, and more preferably from 2.4 to 3.0. Having the specific ratio Tcp/ML₁₊₄ as described above advantageously provides the low heat generation, the break strength, and the elongation at break in a compatible manner. The ratio Tcp/ML₁₊₄ of less than 2.0 degrades the heat build-up. The ratio Tcp/ML₁₊₄ exceeding 3.0 degrades the processability is. The value of the 5 mass % toluene solution viscosity Tcp itself at 25° C. is not limited to a particular value and can be set preferably from 50 cps to 200 cps and more preferably from 80 cps to 180 cps.

When the entire amount of the diene rubber is 100 mass %, the blended amount of the butadiene rubber ranges from 10 mass % to 40 mass %, preferably from 10 mass % to 40 mass %, and more preferably from 15 mass % to 35 mass %. The blended amount of the butadiene rubber of less than 10 mass % degrades the fuel efficiency. The blended amount of the butadiene rubber exceeding 40 mass % decreases the rubber strength decreases, making it difficult to have tire durability.

As described above, although styrene-butadiene rubber can be optionally used in combination as the diene rubber according to an embodiment of the present technology, when the styrene-butadiene rubber is used in combination, the blended amount of the styrene-butadiene rubber preferably ranges from 10 mass % to 40 mass % and more preferably from 15 mass % to 35 mass % with respect to the entire amount of the diene rubber (100 mass %). When the styrene-butadiene rubber is used in combination, an effect of providing hardness and breaking physical properties in a compatible manner can be added.

The rubber composition for tires according to an embodiment of the present technology always contains carbon black as a filler. Blending the carbon black can increase the strength of the rubber composition. In particular, the CTAB adsorption specific surface area of the carbon black used in the present technology is less than 70 m²/g and preferably ranges from 25 m²/g to 50 m²/g and more preferably from 30 m²/g to 45 m²/g. Blending a combination of carbon black having such a large particle diameter and the butadiene rubber described above can increase the rubber hardness while maintaining the low heat build-up. If the CTAB adsorption specific surface area of the carbon black is 70 m²/g or more, the heat build-up degrades.

The blended amount of the carbon black ranges from 35 parts by mass to 60 parts by mass, preferably from 35 parts by mass to 55 parts by mass, and more preferably from 35 parts by mass to 50 parts by mass per 100 parts by mass of the rubber component described above. The blended amount of the carbon black of less than 35 parts by mass degrades the hardness. The blended amount of the carbon black exceeding 60 parts by mass degrades the heat build-up.

The rubber composition for tires according to an embodiment of the present technology always contains silica in addition to carbon black as a filler. Blending the silica in addition to the carbon black can increase the strength of the rubber composition while suppressing the heat build-up to a low level. In particular, the CTAB adsorption specific surface area of the silica used in the present technology is less than 180 m²/g and preferably ranges from 90 m²/g to 180 m²/g and more preferably from 160 m²/g to 180 m²/g. Blending a combination of silica having such a large particle diameter and the modified butadiene rubber described above can increase the rubber hardness while maintaining the low heat build-up. The CTAB adsorption specific surface area of the silica of 180 m²/g or more degrades the heat build-up.

The blended amount of the silica ranges from 3 parts by mass to 30 parts by mass, preferably from 4 parts by mass to 28 parts by mass, and more preferably from 4 parts by mass to 25 parts by mass per 100 parts by mass of the rubber component described above. The blended amount of the silica of less than 3 parts by mass causes the amount of silica to be too small, failing to expect the sufficient effect caused by the silica. The blended amount of the silica exceeding 30 parts by mass degrades the heat build-up.

When carbon black and silica are used in combination as described above, a total blended amount of the filler (total amount of carbon black and silica) is preferably 70 parts by mass or less and more preferably from 40 parts by mass to 60 parts by mass. Suppressing the total blended amount of the filler to a low level in this manner advantageously improves the heat build-up. The total blended amount of the filler exceeding 75 parts by mass may degrade the heat build-up. In addition, a weight ratio of silica to carbon black may be set to preferably from 0.03 to 0.5 and more preferably from 0.08 to 0.3. Setting the weight ratio in this manner satisfactorily balances carbon black and silica, thus advantageously improving the rubber hardness while maintaining the heat build-up low. The weight ratio out of the above range cannot obtain the effect of enhancing the rubber hardness while maintaining the heat build-up low. In particular, the excessive weight ratio of silica may degrade the heat build-up.

The rubber composition according to an embodiment of the present technology may also include other inorganic fillers than the carbon black. Examples of other inorganic fillers include materials typically used for a rubber composition for tires, such as clay, talc, calcium carbonate, mica, and aluminum hydroxide.

In the rubber composition for tires according to an embodiment of the present technology, a silane coupling agent may be used in combination when the silica described above is blended. Blending a silane coupling agent can improve dispersibility of the silica in the diene rubber. The type of silane coupling agent is not particularly limited as long as it is a silane coupling agent that can be used in rubber compositions containing silica. Examples thereof include sulfur-containing silane coupling agents, such as bis(3-triethoxysilylpropyl)tetrasulfide, bis(3-triethoxysilylpropyl)disulfide, 3-trimethoxysilylpropyl benzothiazole tetrasulfide, γ-mercaptopropyl triethoxysilane, and 3-octanoylthiopropyl triethoxysilane. The blended amount of the silane coupling agent is preferably 15 mass % or less and more preferably from 3 mass % to 12 mass % per weight of silica. The blended amount of the silane coupling agent of greater than 15 mass % of the blended amount of the silica condenses the silane coupling agent, failing to obtain desired hardness and strength of the rubber composition.

In the rubber composition for tires according to an embodiment of the present technology, an amine-based anti-aging agent and/or a wax is preferably blended. Blending these can improve cracking resistance and processability. The blended amount of the amine-based anti-aging agent preferably ranges from 1.0 part by mass to 4.0 parts by mass and more preferably from 1.5 parts by mass to 3.5 parts by mass per 100 parts by mass of the rubber component. The blended amount of the wax is preferably greater than 0 parts by mass but not greater than 2.0 parts by mass, and more preferably from 0.1 parts by mass to 2.0 parts by mass per 100 parts by mass of the rubber component. The amine-based anti-aging agent and the wax may be separately blended or may be used in combination. The blended amount of the amine-based anti-aging agent of less than 1.0 part by mass cannot expect the effect of improving the cracking resistance and the processability, reducing, in particular, cracking resistance. The blended amount of the amine-based anti-aging agent of greater than 4.0 parts by mass reduces the processability. The blended amount of the wax of greater than 2.0 parts by mass reduces the processability.

Examples of the amine-based anti-aging agent include N-phenyl N′-(1,3-dimethylbutyl)-p-phenylenediamine, alkylated diphenylamine, 4,4′-bis(α,α-dimethylbenzyl)diphenylamine, N,N′-diphenyl-p-phenylenediamine, N-phenyl-N′-isopropyl-p-phenylenediamine, p-(p-toluenesulfonylamide)diphenylamine, N-phenyl-N′-(3-methacryloyloxy-2-hydroxy propyl)-p-phenylenediamine, and a 2,2,4-trimethyl-1,2-dihydroquinoline polymer, and in particular, N-phenyl N′-(1,3-dimethylbutyl)-p-phenylenediamine can be suitably used.

When the rubber composition for tires according to an embodiment of the present technology contains the amine-based anti-aging agent and is used for the undertread of the tire, the content A of the amine-based anti-aging agent in the cap tread at the groove bottom position of the circumferential groove is preferably more than 0.8 mass % and less than 2.0 mass %, the content B of the amine-based anti-aging agent in the undertread at the position under the circumferential groove is preferably more than 0.7 mass % and less than 1.5 mass %, and the ratio B/A of the content B to the content A is preferably 0.6 or more and 1.2 or less, more preferably from 0.7 to 1.2, and still more preferably from 0.8 to 1.2. This makes the physical properties of the undertread (in particular, physical properties at the groove bottom position) satisfactory, thus advantageously improving the steering stability and the durability (in particular, durability against groove cracks) while reducing the rolling resistance. The ratio B/A of less than 0.6 may decrease the anti-aging agent at a groove bottom, thus decreasing the durability (groove cracking resistance). The ratio B/A exceeding 1.2 may degrade water-resistant adhesiveness of a belt.

In the rubber composition for tires according to an embodiment of the present technology, an amine-ketone-based anti-aging agent can be used in combination as a secondary anti-aging agent. Examples of the amine-ketone-based anti-aging agent include a 2,2,4-trimethyl-1,2-dihydroquinoline polymer. The blended amount of the amine-ketone-based anti-aging agent preferably ranges from 0.3 parts by mass to 3 parts by mass and more preferably from 0.5 parts by mass to 2 parts by mass per 100 parts by mass of the rubber component.

Since the rubber composition for tires according to an embodiment of the present technology is mainly used for the undertread, the blend of the rubber composition constituting the cap tread to be used in combination when used in the tire is not particularly limited. However, as described above, in the relationship between the undertread and the cap tread, the rubber composition constituting the cap tread preferably contains the amine-based anti-aging agent, and the content B is preferably in the above range. In addition, the rubber composition constituting the cap tread preferably contains a wax together with the amine-based anti-aging agent, and a blended amount of the wax preferably ranges from 1 part by mass to 4 parts by mass per 100 parts by mass of the rubber component in the rubber composition constituting the cap tread. The blended amount of the amine-based anti-aging agent in the rubber composition constituting the cap tread preferably ranges from 0.8 to 1.5 times the blended amount of the wax. The small blended amount of the wax in the rubber composition constituting the cap tread may degrade weather resistance, and the large blended amount of the wax may degrade the appearance.

In the rubber composition for tires according to an embodiment of the present technology, sulfur is preferably blended in an amount of preferably from 2.5 parts by mass to 5.0 parts by mass, more preferably from 3.0 parts by mass to 4.5 parts by mass per 100 parts by mass of the rubber component described above. The blended amount of sulfur is an amount of pure sulfur excluding an amount of oil. Blending sulfur in this manner can make rubber physical properties after vulcanization satisfactory. The blended amount of sulfur of less than 2.5 parts by mass may not obtain a desired hardness. The blended amount of sulfur of more than 5.0 parts by mass may degrade fatigue resistance.

In the rubber composition for tires according to an embodiment of the present technology, compounding agents other than those above may also be added. Examples of other compounding agents include various compounding agents generally used in pneumatic tires, such as other reinforcing fillers other than carbon black and silica, vulcanization or crosslinking agents, vulcanization accelerators, anti-aging agents other than amine-based anti-aging agents and amine-ketone-based anti-aging agents, liquid polymers, thermosetting resins, and thermoplastic resins. These compounding agents can be blended in typical amounts conventionally used so long as the object of the present technology is not hindered. As a kneader, a typical kneader for a rubber, such as a Banbury mixer, a kneader, or a roller may be used.

The rubber composition for tires according to an embodiment of the present technology can be manufactured by a general manufacturing method using the kneader described above. However, a release temperature during kneading preferably ranges from 120° C. to 165° C., more preferably from 130° C. to 160° C., and still more preferably from 135° C. to 155° C. When the release temperature is high, particularly when the amine-based anti-aging agent is used, there is a concern that the amine-based anti-aging agent is deactivated by heat and the content of the amine-based anti-aging agent in the rubber composition to be finally obtained decreases. To have the content of the amine-based anti-aging agent in using the amine-based anti-aging agent, it is preferable to perform a plurality of mixing steps without charging a vulcanizing agent and blend the amine-based anti-aging agent in the final step.

When the rubber composition for tires according to an embodiment of the present technology is used for tires, the tire can be manufactured by a general manufacturing method. However, the vulcanization temperature is preferably 145° C. to 170° C. and more preferably 150° C. to 160° C. Setting the temperature condition in this manner can satisfactorily have the physical properties of the rubber composition for tires according to an embodiment of the present technology, thus advantageously improving the steering stability and the durability while reducing the rolling resistance.

The hardness at 20° C. of the rubber composition for tires according to an embodiment of the present technology formed from such composition ranges from 60 to 65 and preferably from 62 to 65. The tensile stress (M100) of the rubber composition for tires according to an embodiment of the present technology at 100% elongation at 100° C. ranges from 2.0 MPa to 4.0 MPa and preferably from 2.3 MPa to 3.5 MPa. In addition, the product (TB×EB) of the tensile strength at break TB (unit: MPa) at 100° C. and the elongation at break EB (unit: %) at 100° C. of the rubber composition for tires according to an embodiment of the present technology is 2000 or more and preferably from 2200 to 5500. Since the rubber composition for tires according to an embodiment of the present technology has such physical properties, it is possible to enhance the steering stability and the durability in tires while reducing the rolling resistance. The hardness of less than 60 degrades the steering stability when a tire is made. The hardness exceeding 65 cannot reduce the rolling resistance. The tensile stress (M100) of less than 2.0 MPa degrades the steering stability when a tire is made. The tensile stress (M100) exceeding 4.0 MPa cannot reduce the rolling resistance. The product (TB×EB) of less than 2000 decreases high-speed durability. The hardness, the tensile stress (M100), and the product (TB×EB) are not only determined by the blending described above and are physical properties that can be adjusted also by, for example, kneading conditions and kneading methods.

In the rubber composition for tires according to an embodiment of the present technology, in addition to the physical properties described above, a loss tangent at 60° C. (tan δ (60° C.)) is preferably 0.07 or less and more preferably from 0.02 to 0.06. Setting tan δ (60° C.) in this manner advantageously improves the steering stability and the durability in tires while reducing the rolling resistance. The tan δ (60° C.) exceeding 0.07 makes it difficult to sufficiently reduce the rolling resistance.

Because the rubber composition for tires according to an embodiment of the present technology has the composition and physical properties described above, the steering stability and the durability can be improved when a tire is formed while the rolling resistance is reduced. Specifically, specific butadiene rubber is used in combination with natural rubber as the rubber component, and a suitable amount of each of carbon black and silica having a large particle diameter is blended as the filler, thus allowing the steering stability and the durability to be enhanced while the rolling resistance is reduced when the rubber composition is used in a tire. In particular, since specific butadiene rubber having the above-described characteristics is used, it is possible to prevent a decrease in steering stability and durability due to a decrease in rubber hardness in reducing heat build-up by using carbon black or silica having a large particle diameter. The blend as described above allows the above-described rubber physical properties to be easily achieved and the steering stability and the durability to be satisfactorily maintained. Their cooperation can improve the above-described performance in a well-balanced manner. Thus, the rubber composition for tires according to an embodiment of the present technology is preferably used for the undertread 11U of the tire, and the tire in which the rubber composition for tires according to an embodiment of the present technology is used for the undertread 11U can improve fuel economy performance while satisfactorily maintaining the steering stability and the durability.

As illustrated in FIG. 1, the tire in which the rubber composition for tires according to an embodiment of the present technology is used for the undertread 11U (hereinafter, referred to as the tire according to an embodiment of the present technology) preferably includes a circumferential groove 20 extending along the tire circumferential direction in the tread portion 1. At this time, an under-groove gauge at a groove bottom of the circumferential groove 20 (a thickness of the tread rubber layer 11 on the inner side in the tire radial direction of a groove bottom of the circumferential groove in a tire meridian cross-section, which is a sum of the rubber gauges G_{U} and G_{C} described later) is G_{T}, a rubber gauge of the cap tread 11C at the groove bottom of the circumferential groove (a thickness of the cap tread 11C on the inner side in the tire radial direction of the groove bottom of the circumferential groove in the tire meridian cross-section) is G_{C}, a rubber gauge of the undertread 11U at the groove bottom of the circumferential groove (a thickness of the undertread 11U on the inner side in the tire radial direction of the groove bottom of the circumferential groove in the tire meridian cross-section) is G_{U}, and the under-groove gauge G_{T} is preferably 2.5 mm or less, more preferably from 1.5 mm to 2.3 mm, and still more preferably from 1.5 mm to 2.0 mm. The ratio G_{U}/G_{C} preferably ranges from 0.3 to 0.8, more preferably from 0.4 to 0.7, and still more preferably from 0.5 to 0.7. Setting the rubber gauge in this manner satisfactorily balances the tread rubber layer 11, the cap tread 11C, and the undertread 11U at the groove bottom position, thus advantageously improving the steering stability and the durability (in particular, durability against groove cracks) while reducing the rolling resistance. G_{T}, G_{U}, and G_{C} are all thicknesses of respective rubber layers (respective pieces of rubber) measured perpendicularly to a surface of the belt layer 7 on a tire outer circumferential side.

At this time, in addition, a cross-sectional area of the undertread in the tire meridian cross-section preferably ranges from 0.15 times to 0.40 times and more preferably from 0.20 times to 0.35 times the cross-sectional area of the tread rubber layer 11 in the tire meridian cross-section (the sum of the cross-sectional area of the undertread 11U and the cross-sectional area of the cap tread 11C). This satisfactorily balances the tread rubber layer 11, the cap tread 11C, and the undertread 11U, thus advantageously improving the steering stability and the durability (in particular, durability against groove cracks) while reducing the rolling resistance.

An embodiment of the present technology will further be described below by way of examples, but the scope of an embodiment of the present technology is not limited to examples.

### Examples

Tires of Standard Example 1, Comparative Examples 1 to 9, and Examples 1 to 11 were manufactured. The tires have a tire size of 245/45 ZR 18 and the basic structure illustrated in FIG. 1 and have the blending, physical properties, and release temperature of the rubber composition constituting the undertread, a tire structure (under-groove gauges G_{T}, G_{U}, and G_{C}) and vulcanization temperature, and the contents A and B and the ratio B/A of the amine-based anti-aging agent in an untraveled tire set as shown in Tables 1 to 3. The vulcanization time was uniformly 15 minutes in all the examples.

In each example, as shown in Tables 1 to 3, the hardness, the tensile stress at 100% elongation at 100° C. (hereinafter, “M100 (100° C.)”), the tensile strength at break TB at 100° C. (hereinafter, “TB (100° C.)”), the elongation at break EB at 100° C. (hereinafter, “EB (100° C.)”), and the product TB×EB were set as the physical properties of the rubber composition. The hardness was measured at a temperature of 20° C. using a type A durometer in accordance with JIS K6253. M100 (100° C.) was measured at a tensile speed of 500 mm/minute and a temperature of 100° C. using a No. 3 dumbbell test piece in accordance with JIS K6251 (unit: MPa). TB (100° C.) was measured at a temperature of 100° C. in accordance with JIS K6251 (unit: MPa). EB (100° C.) was measured at a temperature of 100° C. in accordance with JIS K6251 (unit: %).

The contents A and B of the amine-based anti-aging agent in the untraveled tire were the content A of the amine-based anti-aging agent in the cap tread at the groove bottom position of the circumferential groove and the content B of the amine-based anti-aging agent in the undertread at the groove bottom position of the circumferential groove and were measured by gas chromatography in accordance with JIS K 6229 and JIS K 0114, respectively. Specifically, the tire (untraveled new tire) of each example was disassembled, the cap tread and the undertread at the groove bottom position of the circumferential groove were each thinly sliced, then cut into a test piece having a size of about 1 mm square and a length of about 30 mm, and extracted with acetone for 8 hours, the resulting filtrate was returned to room temperature to obtain a gas chromatographic measurement sample, a solution (standard sample) in which the four-point concentration of the amine-based anti-aging agent to be measured was distributed in the range of from 100 ppm to 1000 ppm was prepared, the area of the obtained gas chromatographic measurement sample was determined, and the content of the amine-based anti-aging agent in the gas chromatographic measurement sample was calculated from the calibration curve.

For the blend of the rubber composition in Tables 1 to 3, not only the blended amount (parts by mass) of the anti-aging agent but also the ratio (mass %) of the anti-aging agent to the weight of the rubber composition (the sum of the blended amount of each material) are listed (“ratio” column in tables).

For the obtained rubber composition, evaluations of steering stability, rolling resistance, high-speed durability, and groove cracking resistance were performed by the following methods.

### Steering Stability

Each of the test tires was assembled on a wheel having a rim size of 18×8.5 J, inflated to an air pressure of 240 kPa, and mounted on a test vehicle having an engine displacement of 2000 cc, and sensory evaluations for steering stability were performed on a test course including a pavement surface by test drivers. The evaluation results were evaluated in five stages with the result of Standard Example 1 as three points (reference). Larger values indicate superior steering stability.

### Rolling Resistance

Each of the test tires was assembled on a wheel of 18×7 J, and the rolling resistance was measured under the conditions of an air pressure of 210 kPa, a load of 4.82 kN, and a speed of 80 km/h in accordance with ISO 28580 using an indoor drum testing machine (drum diameter: 1707.6 mm). The evaluation results are expressed as index values with respect to the measurement value of Standard Example 1 assigned 100. Smaller index values indicate less rolling resistance.

### High-Speed Durability

Each of the test tires was assembled on a wheel of 18×7 J, inflated with an air pressure of 230 kPa, and subjected to a high-speed durability test in accordance with JIS D4230 and by using an indoor drum testing machine (drum diameter: 1707 mm): thereafter subsequently, the speed was increased by 8 km/h every hour, and the distance traveled until failure occurred in the tire was measured. The evaluation results are expressed as index values with respect to the measurement value of Standard Example 1 assigned 100. Larger index values indicate superior high-speed durability.

### Groove Cracking Resistance (High Temperature)

Each of the test tires assembled on a wheel of 18×7 J and inflated with an air pressure of 230 kPa was subjected to an exposure test for 24 hours under the conditions of a temperature of 50° C. and an ozone concentration of 100 phm, and the number of cracks generated in the groove bottom was measured after the test The evaluation results are expressed, by using the reciprocal of the measurement values, as index values with respect to Standard Example 1 assigned 100. A larger index value indicates a smaller number of cracks and superior groove cracking resistance.

### Groove Cracking Resistance (Low Temperature)

Each of the test tires assembled on a wheel of 18×7 J and inflated with an air pressure of 230 kPa was subjected to an exposure test for 24 hours under the conditions of a temperature of 0° C. and an ozone concentration of 100 phm, and the number of cracks generated in the groove bottom was measured after the test The evaluation results are expressed, by using the reciprocal of the measurement values, as index values with respect to Standard Example 1 assigned 100. A larger index value indicates a smaller number of cracks and superior groove cracking resistance.

TABLE 1

| | | Standard | Comparative | Comparative | Comparative |
|---|---|---|---|---|---|
| | | Example 1 | Example 1 | Example 2 | Example 3 |
| NR | Parts by mass | 75 | 75 | 75 | 75 |
| BR1 | Parts by mass | 25 | | | |
| BR2 | Parts by mass | | 25 | | |
| BR3 | Parts by mass | | | 25 | |
| BR4 | Parts by mass | | | | 25 |
| BR5 | Parts by mass | | | | |
| IR | Parts by mass | | | | |
| SBR | Parts by mass | | | | |
| CB1 | Parts by mass | | | | |
| CB2 | Parts by mass | 45 | 45 | 45 | 45 |
| Silica 1 | Parts by mass | | 10 | 10 | 10 |
| Silica 2 | Parts by mass | | | | |
| Silane coupling agent | Parts by mass | | 0.7 | 0.7 | 0.7 |
| Tackifier | Parts by mass | 2 | 2 | 2 | 2 |
| Zinc oxide | Parts by mass | 5 | 5 | 5 | 5 |
| Anti-aging agent | Parts by mass | 1.4 | 2.3 | 2.3 | 2.3 |
| (Ratio Mass %) | | 0.9 | 1.3 | 1.3 | 1.3 |
| Stearic acid | Parts by mass | 1.5 | 1.5 | 1.5 | 1.5 |
| Sulfur | Parts by mass | 3.2 | 4.5 | 4.5 | 4.5 |
| Vulcanization accelerator | Parts by mass | 1.3 | 1.3 | 1.3 | 1.3 |
| Hardness | | 59 | 64 | 64 | 64 |
| M100 (100° C.) | MPa | 2.4 | 2.8 | 2.4 | 2.4 |
| TB (100° C.) | MPa | 9.3 | 9.5 | 10.0 | 10.7 |
| EB (100° C.) | % | 300 | 270 | 270 | 270 |
| TB × EB | | 2790 | 2565 | 2700 | 2889 |
| G_{T} | mm | 2.6 | 2.6 | 2.6 | 2.6 |
| G_{U}/G_{C} | | 0.2 | 0.4 | 0.4 | 0.4 |
| Content A | Mass % | 1.0 | 1.0 | 1.0 | 1.0 |
| Content B | Mass % | 0.8 | 0.8 | 0.8 | 0.8 |
| B/A | | 0.80 | 0.80 | 0.80 | 0.80 |
| Release temperature | ° C. | 170 | 170 | 170 | 170 |
| Vulcanization temperature | ° C. | 175 | 175 | 175 | 175 |
| Steering stability | Rating | 3 | 4 | 4 | 4 |
| Rolling resistance | Index value | 100 | 97 | 100 | 100 |
| High-speed durability | Index value | 100 | 103 | 101 | 10 |
| Groove cracking resistance | Index value | 100 | 105 | 105 | 105 |
| (high temperature) | | | | | |
| Groove cracking resistance | Index value | 100 | 97 | 98 | 98 |
| (low temperature) | | | | | |

| | | Example 1 | Example 2 | Example 3 | Example 4 |
|---|---|---|---|---|---|
| NR | Parts by mass | 50 | 50 | 75 | 75 |
| BR1 | Parts by mass | | | | |
| BR2 | Parts by mass | | | | |
| BR3 | Parts by mass | | | | |
| BR4 | Parts by mass | | | | |
| BR5 | Parts by mass | 25 | 25 | 25 | 25 |
| IR | Parts by mass | 25 | | | |
| SBR | Parts by mass | | 25 | | |
| CB1 | Parts by mass | | | | |
| CB2 | Parts by mass | 45 | 45 | 42 | 45 |
| Silica 1 | Parts by mass | 10 | 10 | 15 | 10 |
| Silica 2 | Parts by mass | | | | |
| Silane coupling agent | Parts by mass | 0.7 | 0.7 | 1.1 | 0.7 |
| Tackifier | Parts by mass | 2 | 2 | 2 | 2 |
| Zinc oxide | Parts by mass | 5 | 5 | 5 | 5 |
| Anti-aging agent | Parts by mass | 2.3 | 2.3 | 2.3 | 2.3 |
| (Ratio Mass %) | | 1.3 | 1.3 | 1.3 | 1.4 |
| Stearic acid | Parts by mass | 1.5 | 1.5 | 1.5 | 1.5 |
| Sulfur | Parts by mass | 4.5 | 4.5 | 4.5 | 4.5 |
| Vulcanization accelerator | Parts by mass | 1.3 | 1.3 | 1.3 | 1.3 |
| Hardness | | 64 | 66 | 65 | 64 |
| M100 (100° C.) | MPa | 2.6 | 2.9 | 2.6 | 2.6 |
| TB (100° C.) | MPa | 10.1 | 11.1 | 11.0 | 10.5 |
| EB (100° C.) | % | 260 | 245 | 295 | 270 |
| TB × EB | | 2626 | 2561 | 3245 | 2835 |
| G_{T} | mm | 2.6 | 2.6 | 2.6 | 2.6 |
| G_{U}/G_{C} | | 0.4 | 0.4 | 0.4 | 0.4 |
| Content A | Mass % | 1.0 | 1.0 | 1.0 | 1.0 |
| Content B | Mass % | 0.8 | 0.8 | 0.8 | 0.8 |
| B/A | | 0.80 | 0.80 | 0.80 | 0.80 |
| Release temperature | ° C. | 170 | 170 | 170 | 170 |
| Vulcanization temperature | ° C. | 175 | 175 | 175 | 175 |
| Steering stability | Rating | 4 | 4 | 4 | 4 |
| Rolling resistance | Index value | 97 | 99 | 98 | 97 |
| High-speed durability | Index value | 103 | 103 | 106 | 104 |
| Groove cracking resistance | Index value | 105 | 106 | 103 | 105 |
| (high temperature) | | | | | |
| Groove cracking resistance | Index value | 103 | 101 | 107 | 102 |
| (low temperature) | | | | | |

TABLE 2

| | | Comparative | Comparative | Comparative |
|---|---|---|---|---|
| | | Example 4 | Example 5 | Example 6 |
| NR | Parts by mass | 75 | 75 | 75 |
| BR1 | Parts by mass | | | |
| BR2 | Parts by mass | | | |
| BR3 | Parts by mass | | | |
| BR4 | Parts by mass | | | |
| BR5 | Parts by mass | 25 | 25 | 25 |
| IR | Parts by mass | | | |
| SBR | Parts by mass | | | |
| CB1 | Parts by mass | 45 | | |
| CB2 | Parts by mass | | 45 | 30 |
| Silica 1 | Parts by mass | | | 10 |
| Silica 2 | Parts by mass | | 10 | |
| Silane coupling agent | Parts by mass | | | 0.7 |
| Tackifier | Parts by mass | 2 | 2 | 2 |
| Zinc oxide | Parts by mass | 5 | 5 | 5 |
| Anti-aging agent | Parts by mass | 2.3 | 2.3 | 2.3 |
| (Ratio Mass %) | | 1.3 | 1.3 | 1.5 |
| Stearic acid | Parts by mass | 1.5 | 1.5 | 1.5 |
| Sulfur | Parts by mass | 4.5 | 4.5 | 4.5 |
| Vulcanization accelerator | Parts by mass | 1.3 | 1.3 | 1.3 |
| Hardness | | 67 | 64 | 54 |
| M100 (100° C.) | MPa | 3.2 | 2.7 | 1.9 |
| TB (100° C.) | MPa | 12.0 | 9.9 | 10.8 |
| EB (100° C.) | % | 260 | 270 | 475 |
| TB × EB | | 3120 | 2673 | 5130 |
| G_{T} | mm | 2.6 | 2.6 | 2.6 |
| G_{U}/G_{C} | | 0.4 | 0.4 | 0.4 |
| Content A | Mass % | 1.0 | 1.0 | 1.0 |
| Content B | Mass % | 0.8 | 0.8 | 0.8 |
| B/A | | 0.80 | 0.80 | 0.80 |
| Release temperature | ° C. | 170 | 170 | 170 |
| Vulcanization temperature | ° C. | 175 | 175 | 175 |
| Steering stability | Rating | 5 | 4 | 2 |
| Rolling resistance | Index value | 104 | 99 | 96 |
| High-speed durability | Index value | 102 | 102 | 100 |
| Groove cracking resistance | Index value | 102 | 98 | 100 |
| (high temperature) | | | | |
| Groove cracking resistance | Index value | 102 | 98 | 96 |
| (low temperature) | | | | |
| | | Comparative | Comparative | Comparative |
| | | Example 7 | Example 8 | Example 9 |
| NR | Parts by mass | 75 | 95 | 50 |
| BR1 | Parts by mass | | | |
| BR2 | Parts by mass | | | |
| BR3 | Parts by mass | | | |
| BR4 | Parts by mass | | | |
| BR5 | Parts by mass | 25 | 5 | 50 |
| IR | Parts by mass | | | |
| SBR | Parts by mass | | | |
| CB1 | Parts by mass | | | |
| CB2 | Parts by mass | 65 | 45 | 45 |
| Silica 1 | Parts by mass | | 10 | 10 |
| Silica 2 | Parts by mass | | | |
| Silane coupling agent | Parts by mass | | 0.7 | 0.7 |
| Tackifier | Parts by mass | 2 | 2 | 2 |
| Zinc oxide | Parts by mass | 5 | 5 | 5 |
| Anti-aging agent | Parts by mass | 2.3 | 2.3 | 2.3 |
| (Ratio Mass %) | | 1.3 | 1.3 | 1.3 |
| Stearic acid | Parts by mass | 1.5 | 1.5 | 1.5 |
| Sulfur | Parts by mass | 4.5 | 4.5 | 4.5 |
| Vulcanization accelerator | Parts by mass | 1.3 | 1.3 | 1.3 |
| Hardness | | 69 | 64 | 63 |
| M100 (100° C.) | MPa | 4.1 | 2.6 | 2.7 |
| TB (100° C.) | MPa | 12.0 | 11.3 | 9.5 |
| EB (100° C.) | % | 225 | 295 | 245 |
| TB × EB | | 2700 | 3333.5 | 2327.5 |
| G_{T} | mm | 2.6 | 2.6 | 2.6 |
| G_{U}/G_{C} | | 0.4 | 0.4 | 0.4 |
| Content A | Mass % | 1.0 | 1.0 | 1.0 |
| Content B | Mass % | 0.8 | 0.8 | 0.8 |
| B/A | | 0.80 | 0.80 | 0.80 |
| Release temperature | ° C. | 170 | 170 | 170 |
| Vulcanization temperature | ° C. | 175 | 175 | 175 |
| Steering stability | Rating | 5 | 4 | 4 |
| Rolling resistance | Index value | 105 | 102 | 96 |
| High-speed durability | Index value | 98 | 102 | 96 |
| Groove cracking resistance | Index value | 100 | 100 | 97 |
| (high temperature) | | | | |
| Groove cracking resistance | Index value | 100 | 100 | 97 |
| (low temperature) | | | | |

TABLE 3

| | | Example 5 | Example 6 | Example 7 | Example 8 |
|---|---|---|---|---|---|
| NR | Parts by mass | 75 | 75 | 75 | 75 |
| BR1 | Parts by mass | | | | |
| BR2 | Parts by mass | | | | |
| BR3 | Parts by mass | | | | |
| BR4 | Parts by mass | | | | |
| BR5 | Parts by mass | 25 | 25 | 25 | 25 |
| IR | Parts by mass | | | | |
| SBR | Parts by mass | | | | |
| CB1 | Parts by mass | | | | |
| CB2 | Parts by mass | 45 | 45 | 45 | 45 |
| Silica 1 | Parts by mass | 10 | 10 | 10 | 10 |
| Silica 2 | Parts by mass | | | | |
| Silane coupling agent | Parts by mass | 0.7 | 0.7 | 0.7 | 0.7 |
| Tackifier | Parts by mass | 2 | 2 | 2 | 2 |
| Zinc oxide | Parts by mass | 5 | 5 | 5 | 5 |
| Anti-aging agent | Parts by mass | 2.3 | 2.3 | 2.3 | 2.3 |
| (Ratio Mass %) | | 1.3 | 1.3 | 1.3 | 1.3 |
| Stearic acid | Parts by mass | 1.5 | 1.5 | 1.5 | 1.5 |
| Sulfur | Parts by mass | 4.5 | 4.5 | 4.5 | 4.5 |
| Vulcanization accelerator | Parts by mass | 1.3 | 1.3 | 1.3 | 1.3 |
| Hardness | | 64 | 64 | 64 | 64 |
| M100 (100° C.) | MPa | 2.6 | 2.6 | 2.6 | 2.6 |
| TB (100° C.) | MPa | 10.5 | 10.5 | 10.5 | 10.5 |
| EB (100° C.) | % | 270 | 270 | 270 | 270 |
| TB × EB | | 2835 | 2835 | 2835 | 2835 |
| G_{T} | mm | 2.2 | 2.2 | 2.2 | 2.6 |
| G_{U}/G_{C} | | 0.2 | 0.5 | 0.9 | 0.4 |
| Content A | Mass % | 1.0 | 1.0 | 1.0 | 0.8 |
| Content B | Mass % | 0.8 | 0.8 | 0.8 | 0.8 |
| B/A | | 0.80 | 0.80 | 0.80 | 1.00 |
| Release temperature | ° C. | 170 | 170 | 170 | 170 |
| Vulcanization temperature | ° C. | 175 | 175 | 175 | 175 |
| Steering stability | Rating | 3 | 3 | 4 | 4 |
| Rolling resistance | Index value | 98 | 95 | 94 | 97 |
| High-speed durability | Index value | 105 | 106 | 104 | 106 |
| Groove cracking resistance | Index value | 106 | 107 | 101 | 103 |
| (high temperature) | | | | | |
| Groove cracking resistance | Index value | 106 | 107 | 102 | 104 |
| (low temperature) | | | | | |

| | | Example 9 | Example 10 | Example 11 |
|---|---|---|---|---|
| NR | Parts by mass | 75 | 75 | 75 |
| BR1 | Parts by mass | | | |
| BR2 | Parts by mass | | | |
| BR3 | Parts by mass | | | |
| BR4 | Parts by mass | | | |
| BR5 | Parts by mass | 25 | 25 | 25 |
| IR | Parts by mass | | | |
| SBR | Parts by mass | | | |
| CB1 | Parts by mass | | | |
| CB2 | Parts by mass | 45 | 45 | 45 |
| Silica 1 | Parts by mass | 10 | 10 | 10 |
| Silica 2 | Parts by mass | | | |
| Silane coupling agent | Parts by mass | 0.7 | 0.7 | 0.7 |
| Tackifier | Parts by mass | 2 | 2 | 2 |
| Zinc oxide | Parts by mass | 5 | 5 | 5 |
| Anti-aging agent | Parts by mass | 2.3 | 2.3 | 2.3 |
| (Ratio Mass %) | | 1.3 | 1.3 | 1.3 |
| Stearic acid | Parts by mass | 1.5 | 1.5 | 1.5 |
| Sulfur Parts by mass | | 4.5 | 4.5 | 4.5 |
| Vulcanization accelerator | Parts by mass | 1.3 | 1.3 | 1.3 |
| Hardness | | 64 | 64 | 64 |
| M100 (100° C.) | MPa | 2.6 | 2.6 | 2.6 |
| TB (100° C.) | MPa | 10.5 | 10.5 | 10.5 |
| EB (100° C.) | % | 270 | 270 | 270 |
| TB × EB | | 2835 | 2835 | 2835 |
| G_{T} | mm | 2.6 | 2.6 | 2.6 |
| G_{U}/G_{C} | | 0.4 | 0.4 | 0.4 |
| Content A | Mass % | 1.0 | 1.0 | 1.0 |
| Content B | Mass % | 0.6 | 1.1 | 1.1 |
| B/A | | 0.60 | 1.10 | 1.10 |
| Release temperature | ° C. | 185 | 155 | 155 |
| Vulcanization temperature | ° C. | 175 | 175 | 165 |
| Steering stability | Rating | 4 | 4 | 5 |
| Rolling resistance | Index value | 97 | 97 | 95 |
| High-speed durability | Index value | 104 | 104 | 107 |
| Groove cracking resistance | Index value | 101 | 107 | 109 |
| (high temperature) | | | | |
| Groove cracking resistance | Index value | 102 | 107 | 110 |
| (low temperature) | | | | |

Types of raw materials used as indicated in Tables 1 to 3 are described below.
NR: natural rubber, TSR20
BR1: butadiene rubber, Nipol BR 1220 (cis-1,4 bond content: 98%, Mooney viscosity ML₁₊₄ at 100° C.: 43, 5 mass % toluene solution viscosity Tcp at 25° C.: 60.2 cps, ratio Tcp/ML₁₊₄:1.4) available from Zeon Corporation
BR2: terminal modified butadiene rubber, Nipol BR 1250 H (cis-1,4 bond content: 35%, Mooney viscosity ML₁₊₄ at 100° C.: 59) available from Zeon Corporation
BR3: butadiene rubber, UBEPOL BR 230 (cis-1,4 bond content: 98%, Mooney viscosity ML₁₊₄ at 100° C.: 38, 5 mass % toluene solution viscosity Tcp at 25° C.: 117.8 cps, ratio Tcp/ML₁₊₄:3.1) available from Ube Industries, Ltd.
BR4: butadiene rubber, UBEPOL BR 150L (cis-1,4 bond content: 98%, Mooney viscosity ML₁₊₄ at 100° C.: 43, 5 mass % toluene solution viscosity Tcp at 25° C.: 120.4 cps, ratio Tcp/ML₁₊₄:2.8) available from Ube Industries, Ltd.
BR5: butadiene rubber, UBEPOL BR 360L (cis-1,4 bond content: 98%, Mooney viscosity ML₁₊₄ at 100° C.: 47, 5 mass % toluene solution viscosity Tcp at 25° C.: 131.6 cps, ratio Tcp/ML₁₊₄:2.8) available from Ube Industries, Ltd.
IR: isoprene rubber, Nipol IR2200, available from Zeon Corporation
SBR: Nipol 1502 available from Zeon Corporation
CB1: carbon black, SEAST 3 (CTAB adsorption specific surface area: 82 m²/g), available from Tokai Carbon Co., Ltd.
CB2: carbon black, SEAST F (CTAB adsorption specific surface area: 47 m²/g), available from Tokai Carbon Co., Ltd.
Silica 1: Ultrasil VN3 (CTAB adsorption specific surface area: 175 m²/g) available from Evonick Japan Co., Ltd.
Silica 2: ZEOSIL Premium 200MP (CTAB adsorption specific surface area: 200 m²/g), available from Solvay Japan, Ltd.
Silane coupling agent: Si69, available from Evonick Japan Co., Ltd.
Tackifier: Hitanol 1502 Z available from Hitachi Chemical Company, Ltd.
Zinc oxide: Zinc Oxide Type III, available from Seido Chemical Industry Co., Ltd.
Anti-aging agent: amine-based anti-aging agent, Santflex 6PPD, available from Flexsys
Stearic acid: Stearic acid 50S, available from New Japan Chemical Co., Ltd.
Sulfur: insoluble sulfur, MUCRON OT-20, available from Shikoku Chemicals Corporation
Vulcanization accelerator: NS-G, available from Sanshin Chemical Industry Co., Ltd.

Tables 1 to 3 clearly shows that the tires of Examples 1 to 11 improved the steering stability and the durability (groove cracking resistance in high-speed durability, high-temperature condition, and low-temperature condition) while reducing the rolling resistance as compared with Standard Example 1 and provided these performances in a well-balanced and compatible manner.

On the other hand, the tire of Comparative Example 1 included the butadiene rubber blended in the rubber composition constituting the undertread that is a terminal modified butadiene rubber and had the low cis-1,4 bond content, thus degrading the durability (groove cracking resistance under the low-temperature condition). The tire of Comparative Example 2 had the small Mooney viscosity ML₁₊₄ of the butadiene rubber blended in the rubber composition constituting the undertread and the large ratio Tcp/ML₁₊₄, failing to reduce the rolling resistance and degrading the durability (groove cracking resistance under the low-temperature condition). The tire of Comparative Example 3 had the small Mooney viscosity ML₁₊₄ of the butadiene rubber blended in the rubber composition constituting the undertread, failing to reduce the rolling resistance and degrading the durability (groove cracking resistance under the low-temperature condition).

The tire of Comparative Example 4 had a large CTAB adsorption specific surface area of the carbon black blended in the rubber composition constituting the undertread, degrading the rolling resistance. The tire of Comparative Example 5 had the large CTAB adsorption specific surface area of silica blended in the rubber composition constituting the undertread, degrading the durability (groove cracking resistance under the high-temperature condition and the low-temperature condition). The tire of Comparative Example 6 had the small blended amount of carbon black in the rubber composition constituting the undertread, failing to obtain the effect of improving the durability and degrading the steering stability. The tire of Comparative Example 7 had the large blended amount of carbon black in the rubber composition constituting the undertread, degrading the rolling resistance and the high-speed durability. The tire of Comparative Example 8 had the small blended amount of the butadiene rubber in the rubber composition constituting the undertread, degrading the rolling resistance. The tire of Comparative Example 9 had the large blended amount of the butadiene rubber in the rubber composition constituting the undertread, degrading the durability (high-speed durability, groove cracking resistance under the high-temperature condition and the low-temperature condition).

1-9. (canceled)

10. A rubber composition for tires, comprising
from 35 parts by mass to 60 parts by mass of carbon black having a CTAB adsorption specific surface area of less than 70 m²/g and from 3 parts by mass to 30 parts by mass of silica having a CTAB adsorption specific surface area of less than 180 m²/g blended per 100 parts by mass of a rubber component containing 50 mass % or more of natural rubber and from 10 mass % to 40 mass % of butadiene rubber,
the butadiene rubber being an unmodified butadiene rubber having a cis-1,4 bond content of 97% or more, a Mooney viscosity ML₁₊₄ at 100° C. of 45 or more, and a ratio Tcp/ML₁₊₄ of a 5 mass % toluene solution viscosity Tcp (unit: cps) at 25° C. to the Mooney viscosity ML₁₊₄ ranging from 2.0 to 3.0.

11. The rubber composition for tires according to claim 10, wherein the rubber component further comprises isoprene rubber or styrene-butadiene rubber.

12. The rubber composition for tires according to claim 10, wherein
hardness at 20° C. ranges from 60 to 65,
tensile stress (M100) at 100% elongation at 100° C. ranges from 2.0 MPa to 4.0 MPa, and
a product (TB×EB) of tensile strength at break TB (unit: MPa) at 100° C. and elongation at break EB (unit: %) at 100° C. is 2000 or more.

13. A tire comprising:
a tread portion extending in a tire circumferential direction and having an annular shape;
a cap tread constituting a road contact surface of the tread portion; and
an undertread disposed on an inner circumferential side of the cap tread;
the undertread including a rubber composition for tires according to claim 10.

14. The tire according to claim 13, wherein an under-groove gauge G_{T} at a groove bottom of a circumferential groove formed in the tread portion is 2.5 mm or less.

15. The tire according to claim 14, wherein a ratio G_{U}/G_{C} of a rubber gauge G_{U} of the undertread to a rubber gauge G_{C} of the cap tread at the groove bottom of the circumferential groove ranges from 0.3 to 0.8.

16. The tire according to claim 13, wherein from 1.0 part by mass to 4.0 parts by mass of an amine-based anti-aging agent is blended per 100 parts by mass of the rubber component.

17. The tire according to claim 16, wherein
a content A of the amine-based anti-aging agent in the cap tread at a groove bottom position of the circumferential groove is more than 0.8 mass % and less than 2.0 mass %,
a content B of the amine-based anti-aging agent in the undertread at the groove bottom position of the circumferential groove is more than 0.7 mass % and less than 1.5 mass %, and
a ratio B/A of the content B to the content A is 0.6 or more and 1.2 or less.

18. A method for manufacturing a tire according to claim 13, a vulcanization temperature ranging from 145° C. to 170° C.

19. The rubber composition for tires according to claim 11, wherein
hardness at 20° C. ranges from 60 to 65,
tensile stress (M100) at 100% elongation at 100° C. ranges from 2.0 MPa to 4.0 MPa, and
a product (TB×EB) of tensile strength at break TB (unit: MPa) at 100° C. and elongation at break EB (unit: %) at 100° C. is 2000 or more.

20. A tire comprising:
a tread portion extending in a tire circumferential direction and having an annular shape;
a cap tread constituting a road contact surface of the tread portion; and
an undertread disposed on an inner circumferential side of the cap tread;
the undertread including a rubber composition for tires according to claim 19.

21. The tire according to claim 20, wherein an under-groove gauge G_{T} at a groove bottom of a circumferential groove formed in the tread portion is 2.5 mm or less.

22. The tire according to claim 21, wherein a ratio G_{U}/G_{C} of a rubber gauge G_{U} of the undertread to a rubber gauge G_{C} of the cap tread at the groove bottom of the circumferential groove ranges from 0.3 to 0.8.

23. The tire according to claim 22, wherein from 1.0 part by mass to 4.0 parts by mass of an amine-based anti-aging agent is blended per 100 parts by mass of the rubber component.

24. The tire according to claim 23, wherein
a content A of the amine-based anti-aging agent in the cap tread at a groove bottom position of the circumferential groove is more than 0.8 mass % and less than 2.0 mass %,
a content B of the amine-based anti-aging agent in the undertread at the groove bottom position of the circumferential groove is more than 0.7 mass % and less than 1.5 mass %, and
a ratio B/A of the content B to the content A is 0.6 or more and 1.2 or less.

25. A method for manufacturing a tire according to claim 24, a vulcanization temperature ranging from 145° C. to 170° C.
